(19) United States
(12) Patent Application Publication
(10) Pub. No.: US 2024/0377496 A1
(43) Pub. Date: Nov. 14, 2024

(54) METHOD AND DEVICES FOR TIMING ERROR MITIGATION FOR THE IMPROVEMENT OF RELATIVE TIME OF ARRIVAL MEASUREMENT ACCURACY

(71) Applicant: Nokia Technologies Oy, Espoo (FI)

(72) Inventors: Hyun-Su CHA, Naperville, IL (US); Ryan KEATING, Naperville, IL (US)

(21) Appl. No.: 18/691,288

(22) PCT Filed: Sep. 7, 2022
(86) PCT No.: PCT/EP2022/074778

§ 371 Date: Mar. 12, 2024

Related U.S. Application Data
(60) Provisional application No. 63/251,490, filed on Oct. 1, 2021.

(51) Int. Cl. G01S 5/02; G01S 5/00

(52) U.S. Cl. CPC G01S 5/0244; G01S 5/0036; G01S 5/0081; G01S 5/021

(57) ABSTRACT

In some embodiments, there is disclosed a method that includes determining, for a transmit timing error group of one or more antennas, an indicator of whether a common transmit timing error that is within in a threshold margin is to be used to characterize the one or more antennas; and reporting the indicator to a network node to enable a determination of whether to perform a time error calibration on one or more measurements performed on one or more reference signal resources. Related systems, methods, and articles of manufacture are also disclosed.

### FIELD

The subject matter described herein relates to wireless communications.

### BACKGROUND

In cellular system development, the new radio (NR, also referred to as 5G) radio access network (RAN) may include positioning support. Specifically, the positioning techniques for NR may include downlink time difference of arrival (DL-TDOA), uplink time difference of arrival (UL-TDOA), downlink angle of departure (DL-AoD), uplink angle of arrival (UL-AoA), multi-cell round trip time (Multi-RTT), and/or the like. These positioning techniques may be used to estimate a physical location of a UE. The positioning reference signal (PRS) and/or sounding reference signal (SRS) may be used as reference signals for estimating the location of the UE. The PRS is a reference signal for positioning in the downlink (DL), and the SRS is a reference signal that may be used for positioning in the uplink (UL). The SRS may, however, be used for purposes other than positioning. In the NR system for example, there are two types of SRS, which are separately configured to a UE by the gNB. The first SRS is for multiple input multiple output (MIMO), and the other SRS is for positioning purposes, where the SRS for MIMO can also be used for positioning. In the uplink-based positioning, the UE may transmit one or multiple SRS resources to one or more transmission reception points (TRPs), and each TRP may measure relative time of arrival (RTOA) and/or angle of arrival (AoA), such that a base station, such as a gNB, sends the measurements to a location management function (LMF).

### SUMMARY

In some example embodiments, there may be provided a method that includes determining, for a transmit timing error group of one or more antennas, an indicator of whether a common transmit timing error that is within in a threshold margin is to be used to characterize the one or more antennas; and reporting the indicator to a network node to enable a determination of whether to perform a time error calibration on one or more measurements performed on one or more reference signal resources.

In some variations, one or more of the features disclosed herein including the following features can optionally be included in any feasible combination. The indicator may include a transmit calibration indicator. The indicator may be determined for each of the one or more reference signal resources. The indicator may be reported with a transmit error group identifier. The configuration information including one or more reference signal resources may be received on an uplink, wherein for each of the one or more reference signal resources, the determining includes determining a corresponding indicator and a corresponding transmit timing error group identifier. The network node comprises, or is comprised in, at least one of a location management function or a base station. The indicator may be reported via radio resource control message and/or a positioning protocol. The indicator may be reported as event based reporting, and wherein the event includes a change of the indicator for the one or more reference signal resources. The one or more reference signal resources may include one or more sounding reference signal resources, one or more sidelink reference signals, and/or one or more physical random access channel resources.

In some example embodiments, there may be provided a method that includes receiving, for a transmit timing error group of antennas, an indicator of whether a common transmit timing error that is within a threshold margin is to be used to characterize one or more antennas; receiving one or more measurements performed on one or more reference signal resources; and determining, based on the indicator, whether to perform a time error calibration on the one or more measurements.

In some variations, one or more of the features disclosed herein including the following features can optionally be included in any feasible combination. In response to the indicator being determined as indicating that the common transmit timing error exceeds the threshold margin, the time error calibration may be performed on the one or more measurements for one or more reference signal resources. The receiving may further include receiving a first transmit timing error group identifier and a first indicator value for a first reference signal resource and further receiving the first transmit timing error group identifier and a second indicator value for a second reference signal resource. In response to the indicator being determined as indicating that the common transmit timing error does not exceed the threshold margin, there may be an inhibition of the performance of the time error calibration on the one or more measurements for one or more reference signal resources. The receiving may further include receiving a first transmit error group identifier and a first indicator value for a first reference signal resource and further receiving the first transmit error group identifier and the first indicator value for a second reference signal resource. The indicator may be received with a transmit timing error group identifier. The one or more reference signal resources may include one or more sounding reference signal resources, one or more sidelink reference signals, and/or one or more physical random access channel resources.

The above-noted aspects and features may be implemented in systems, apparatus, methods, and/or articles depending on the desired configuration. The details of one or more variations of the subject matter described herein are set forth in the accompanying drawings and the description below. Features and advantages of the subject matter described herein will be apparent from the description and drawings, and from the claims.

### DESCRIPTION OF DRAWINGS

In the drawings,

FIG. 1 depicts a user equipment including a plurality of transmit antennas having similar transmit timing error margin, in accordance with some example embodiments.

FIG. 2 depicts an example process for indicating to a network node whether to calibrate measurements associated with a transmit error group of one or more antennas, in accordance with some example embodiments;

FIG. 3A depicts an example of a process for determining an indicator, such as a TXCI, in accordance with some example embodiments;

FIG. 3B depicts an example of a process for determining whether to calibrate based on an indicator, in accordance with some example embodiments;

FIG. 4 depicts an example of a network node, in accordance with some example embodiments; and

FIG. 5 depicts an example of an apparatus, in accordance with some example embodiments.

Like labels are used to refer to same or similar items in the drawings.

### DETAILED DESCRIPTION

Improved positioning accuracy may be provided by reducing the user equipment (UE) receive transmit delay and/or transmit timing delay and/or base station (e.g., gNB type base station) receive transmit delay and/or transmit timing delay using downlink (DL), uplink (UL), and/or DL plus UL positioning techniques and/or UE-based (or assisted) positioning. From a signal transmission perspective, there may be a time delay from the time when the digital signal is generated at baseband to the time when the radio frequency (RF) signal is transmitted from the transmit antenna. And from a signal reception perspective, there may be a time delay from the time when the RF signal arrives at the receive antenna to the time when the signal is digitized and time-stamped at the baseband. With group delay for example, the transmit and/or receive antenna panels (or RF chains associated with the panels) in the UE (or in the gNB) may have different timing error. The group delays may be viewed as an un-compensated delay from the baseband circuitry of the UE (or gNB) to the antenna (or antenna panel having one or more antenna elements). This group delay may vary between UEs, gNBs, and even within the antenna panels (or associated RF chains. For example, within a given device, such as a UE or gNB, the group delay may vary between from the RF baseband circuitry to a given antenna panel. With respect to timing errors in the radio (or physical layer), Table 1 provides definitions for some of the timing errors.

TABLE 1
Tx timing error: From a signal transmission perspective, there will be a time delay
from the time when the digital signal is generated at baseband to the time when the
RF signal is transmitted from the Tx antenna. For supporting positioning, the
UE/TRP may implement an internal calibration/compensation of the Tx time delay
for the transmission of the DL PRS/UL SRS signals, which may also include the
calibration/compensation of the relative time delay between different RF chains in
the same TRP/UE. The compensation may also possibly consider the offset of the
Tx antenna phase center to the physical antenna center. However, the calibration
may not be perfect. The remaining Tx time delay after the calibration, or the
uncalibrated Tx time delay is defined as Tx timing error.
Rx timing error: From a signal reception perspective, there will be a time delay
from the time when the RF signal arrives at the Rx antenna to the time when the
signal is digitized and time-stamped at the baseband. For supporting positioning,
the UE/TRP may implement an internal calibration/compensation of the Rx time
delay before it reports the measurements that are obtained from the DL PRS/UL
SRS signals, which may also include the calibration/compensation of the relative
time delay between different RF chains in the same TRP/UE. The compensation
may also possibly consider the offset of the Rx antenna phase center to the physical
antenna center. However, the calibration may not be perfect. The remaining Rx
time delay after the calibration, or the uncalibrated Rx time delay is defined as Rx
timing error.
UE Tx ‘timing error group’ (UE Tx TEG): A UE Tx TEG is associated with the
transmissions of one or more UL SRS resources for the positioning purpose, which
have the Tx timing errors within a certain margin.
TRP Tx ‘timing error group’ (TRP Tx TEG): A TRP Tx TEG is associated with
the transmissions of one or more DL PRS resources, which have the Tx timing
errors within a certain margin.
UE Rx ‘timing error group’ (UE Rx TEG): A UE Rx TEG is associated with one
or more DL measurements, which have the Rx timing errors within a certain
margin.
TRP Rx ‘timing error group’ (TRP Rx TEG): A TRP Rx TEG is associated with
one or more UL measurements, which have the Rx timing errors within a margin.
UE RxTx ‘timing error group’ (UE RxTx TEG): A UE RxTx TEG is associated
with one or more UE Rx-Tx time difference measurements, and one or more UL
SRS resources for the positioning purpose, which have the ‘Rx timing errors + Tx
timing errors' within a certain margin.
TRP RxTx ‘timing error group’ (TRP RxTx TEG): A TRP RxTx TEG is
associated with one or more gNB Rx-Tx time difference measurements and one or
more DL PRS resources, which have the ‘Rx timing errors + Tx timing errors'
within a certain margin.

Referring to Table 1, a transmit (Tx) timing error group (TEG) of a UE (or a gNB) may be associated with a specific transmit (Tx) antenna (or an antenna panel) of the UE (or gNB). Similarly, a receive (Rx) TEG of a UE (or a gNB) may be associated with a specific receive (RX) antenna (or an antenna panel or RF chain) of the UE (or the gNB). But the TEG may not be limited to a physical antenna panel. The UE may be configured to provide the Rx TEG information associated with a reference signal time difference (RSTD) measurement for DL-TDOA, and the transmission reception point (TRP, which refers to an antenna or an array available to the cellular network for transmission and reception to UEs) may provide association information of the positioning reference signal (PRS) resource(s) with a Tx TEG. The UE may inform a location management function (LMF) of (1) which receive panel (or RF chain or receive antenna) is being used for the reference signal time difference measurement of a positing reference signal and (2) which transmit panel (or RF chain or transmit antenna) of the TRP is used to transmit the PRS resource.

In the case of uplink based positioning, the UE may provide association information of the uplink sounding reference (SRS) resource(s) with the transmit (Tx) TEG information. And, the TRP may provide to the location management function (LMF) association information relative time of arrival (RTOA) measurements with the TRP receive (Rx) TEG.

With respect to providing association information of the uplink (UL) SRS resource(s) with the UE Tx TEG, the UE may provide the association information of the UL SRS resources for positioning with Tx TEGs directly to the LMF, if the UE has one or multiple Tx TEGs. Alternatively, the UE may provide the association information of UL SRS resources for positioning with Tx TEGs to the serving gNB, if the UE has one or multiple Tx TEGs.

With respect to informing the location management function (LMF) of the UE Tx timing error value for each Tx TEG, this may be performed in a variety of ways. For example, the TRP (or reference device(s)) may estimate the timing error of each Tx TEG of the UE or estimates the time error difference between Tx TEG, and the TRP (or reference device(s)) provides to the location management function the Tx time error information of the UE. The reference device may be a UE or a TRP, the location of which is accurately known to the LMF. Alternatively, the UE may provide its Tx time error information for each Tx TEG directly to the location management function. For mitigating UE receive (Rx) and/or transmit (Tx) timing errors for the multi-round trip time positioning method, the UE Tx TEG ID may be associated with an UL SRS resource corresponding to the Tx timing of the UE Rx-Tx measurement, or may be associated with Tx timing of the UE Rx-Tx. And, the UE Tx TEG ID may be associated with one or multiple SRS resources.

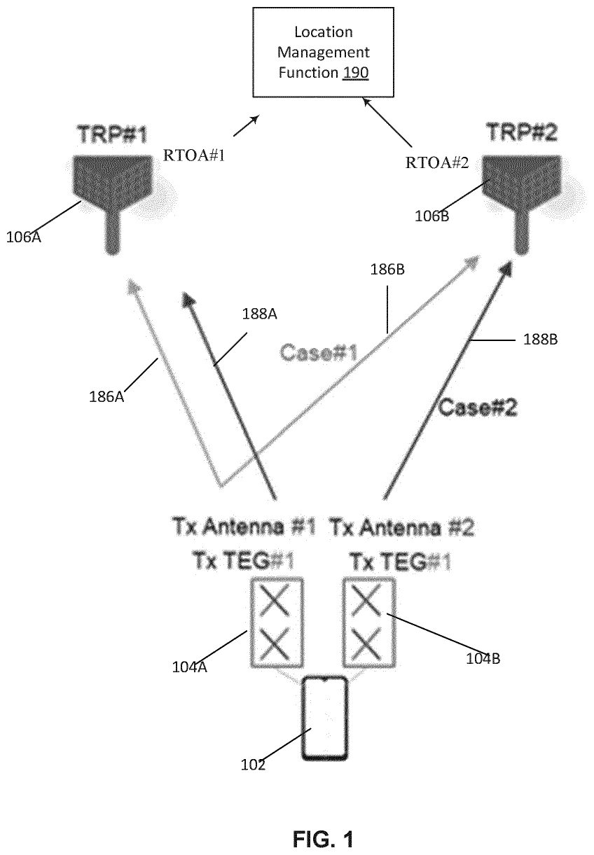

Multiple antennas (or panels of antennas) may share the same transmit timing error group (TEG) identifier (ID) as each TEG is identified or associated with a certain timing error or range of timing errors. To illustrate, FIG. 1 depicts a location management function 190, a first transmission reception point (TRP #1) 106A, a second transmission reception point (TRP #2) 106B, and a UE 102 that includes two transmit (Tx) antennas 104A-B. But these two antennas 104A-B have a similar transmit (Tx) timing error margin, so in this example the two UE transmit antennas 104A-B may share the same Tx TEG ID, which in this example is TX TEG #1.

In a first example (referred to as case #1 and labeled as 186A-B), the location management function may calculate for example the reference signal time difference (RSTD, time difference of RTOA) based on the reported information using, for example, relative time of arrival measurements (RTOA) such as RTOA #1 and RTOA #2 measurements from the TRP #1 106A and TRP #2 106B respectively. Both TRP 106A-B estimates of the RTOA measurement (e.g., RTOA #1 and RTOA #2) use the SRS resource #1 186A and SRS resource #2 186B transmitted from the UE Tx antenna #1 104A. And, both of the SRS resource #1 and SRS resource #2 are associated with the same transmit timing error group, such as Tx TEG #1.

In a second example (referred to as case #2 and labeled 188A-B), the location management function 190 may calculate for example the reference signal time difference (time difference of RTOA) based on the reported information using for example the RTOA #1 and RTOA #2 measurements from TRP #1 106A and TRP #2 106B. In the second example, TRP #1 106A obtains the RTOA measurement (e.g., RTOA #1) by using SRS resource #1 188A transmitted from the UE Tx antenna #1 104A, and the TRP #2 106B obtains the RTOA measurement (e.g., RTOA #2) by using SRS resource #2 188B transmitted from the UE Tx antenna #2 104B. In this example, both the SRS resource #1 and SRS resource #2 are associated with Tx TEG #1.

With respect to first example (case #1), the location management function 190 may need to calculate a time difference value using the RTOA #1 and RTOA #2 values without the need to perform compensation (or calibration) for RTOA #1 and RTOA #2 considering the timing error information on the UE Tx TEG (since the location management function's calculation of the time difference between RTOA #1 and RTOA #2 removes the common or shared timing error contained in RTOA #1 and RTOA #2). Depending on the time gap between the transmission of SRS resource #1 and the transmission of the SRS resource #2, the location management function may need still to perform a calibration for one or both of the RTOA measurements, even if the two SRS resources are transmitted by the same Tx antenna and the same Tx TEG; here the location management function may not be able to know whether or not to calibrate the measurement. Furthermore, if a calibration is not necessary and the location management function nonetheless calibrates the measurement considering Tx TEG #1, it can result in an unnecessary measurement error.

With respect to second example (case #2), the location management function 190 may also calculate the time difference value using RTOA #1 and RTOA #2, but here the appropriate location management function operation is almost always to calibrate both RTOA measurements as transmit timing errors of the SRS resource #1 188A and SRS resource #2 188B are not the same. As both SRS resources in this example are associated with Tx TEG #1, the error range is the same but not the same error value. As the location management function only knows Tx TEG information, it may be possible that the LMF considers the calibration of both RTOA measurements not necessary since the LMF may be able to assume that SRS resource #1 and SRS resource #2 were transmitted by the same Tx antenna.

The two noted examples are for purposes of simply illustrating a problem with two antennas, although the problem can be extended to other quantities of antennas as well (e.g., four, eight, etc.).

In some example embodiments, there is disclosed ways of having the location management function (LMF) know if the location management function should calibrate or not the RTOA measurements associated with the TEGs. For example, there may be provided a method for the UE to inform the location management function whether a calibration is necessary for the RTOA measurements reported by the gNB.

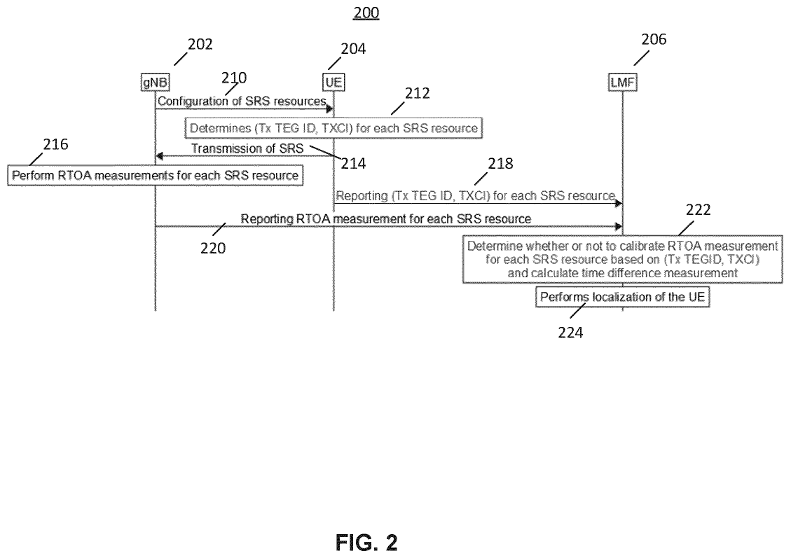

FIG. 2 depicts an example process 200 for indicating to a location management function whether to calibrate RTOA measurements associated with a transmit error group (TEG) of antennas, in accordance with some example embodiments. FIG. 2 depicts a base station 202 (e.g., a gNB), a user equipment (UE) 204, and a location management function (LMF) 206.

At 210, the gNB 202 may configure the UE 204 with resources, in accordance with some example embodiments. For example, the gNB 202 may provide to the UE 204 configuration information. This configuration information may indicate the sounding reference signal (SRS) resources to be used on the uplink(s). The sounding reference signal (SRS) is an uplink reference signal transmitted by the UE to the gNB to allow the gNB to assess channel quality (e.g., channel effects on multipath fading, scattering, Doppler, and power loss of transmitted signal, etc.). The SRS used to assess channel quality may also be used for positioning. The configuration information may include the SRS resources for positioning purpose. To illustrate further, the UE may be configured with the SRS resources and their associated SRS resource set(s) (which are provided at 210). A SRS resource set may include one or more SRS resource(s), and each SRS resource set is identified with an identifier.

Given the SRS resources, the UE 204 may then determine at 212 a specific transmit antenna to transmit each SRS via a corresponding SRS resource, in accordance with some example embodiments. Given that the UE knows which antenna is being used to transmit each SRS resource, the UE may determine at 212 the transmit error group (TEG) ID and/or a transmit calibration indicator (TXCI) for each SRS resource.

To determine a timing error group (TEG), the TEG may be identified with an identifier (ID) and a certain error range, such as [0, X ns]. By way of an example and for purposes of illustration, if the UE is equipped with two Tx antenna panels, each antenna panel may have different error ranges with respect to timing error. In this example, there may be two different Tx TEGs, such as Tx TEG #1: [0, 5 nanosecond] error range (or margin) associated with Tx antenna panel #1 and Tx TEG #2: [0, 10 nanosecond] error range (or margin) associated with Tx antenna panel #2, although other timing error range values (or delay, time, etc.) may be used as the noted error range values are for illustration. If SRS resources #1, #2, and #3 are transmitted by the same Tx antenna panel #1 104A, these SRSs may have the same Tx timing error range, so in this example they may be associated with a specific Tx TEG, such as Tx TEG #1. In other words, the same UE Tx TEG may be associated with the transmissions of one or more uplink SRS resources, which have the Tx timing errors within a threshold margin or range (e.g., the 0 to 5 nanoseconds noted above), where the SRS may be for MIMO SRS or positioning SRS.

The following provides an example of determining a TXCI using an example where there are different TEGs. Referring again to FIG. 1, suppose for example Tx antenna #2 104B is associated with Tx TEG #2, so Tx antenna #2 has different Tx timing error than Tx antenna #1 104A. If the two TRPs 106A-B obtain two RTOA measurements using the SRS resource #1 and SRS resource #2 carried on the corresponding uplinks, where SRS resource #1 is transmitted from Tx antenna #1 (associated with Tx TEG #1) and SRS resource #2 is transmitted from Tx antenna #2 (associated with Tx TEG #2), the RTOA #1 and RTOA #2 measurements are respectively associated with two different UE Tx TEGs. In this example, even if the TXCI has the same value, the LMF may calibrate the RTOA #1 and RTOA #2 as the RTOAs are associated with different Tx TEGs. If for example, the UE reports (e.g., Tx TEG #1, TXCI #1) for SRS resource #1 and reports (Tx TEG #2, TXCI #1) for SRS resource #2, the LMF may calibrate RTOA #1 and RTOA #2 based on the different TxTEG ID (without considering the TXCI).

The following provides an example of determining a TXCI using an example having the same TEGs. Referring again to FIG. 1, suppose three SRS resources where SRS resource #1 and SRS resource #2 are transmitted from Tx antenna #1 104A and SRS resource #3 is transmitted from Tx antenna #2 104B. These two Tx antennas are associated with the same Tx TEG #1. In the case of a TXCI for different antennas, for the SRS resource #3, the UE may report different TXCI value(s) than the TXCI value(s) for SRS resource #1 and resource #2 since SRS resource #3 is transmitted different antennas. In the case however of the TXCI for the same antenna, for SRS resource #1 and SRS resource #2, if the gap of the transmission time of the two SRS resources is small (e.g., less than a certain threshold or time gap such as 10 ms), the UE may decide two SRS resources may have the common timing error. However, even if the gap of the transmission time of the two SRS resources is not small (e.g., more than a certain threshold or time gap such as 10 ms), the UE may be able to decide the two SRS resources may have the common timing error assuming timing error has a nearly similar value for a certain time duration (e.g., the UE reports (Tx TEG #1, TXCI #1) for SRS resource #1 and reports (Tx TEG #1, TXCI #1) for SRS resource #2). In other words, the UE may decide multiple SRS resources have the common group delay, where these SRS resources are transmitted within a certain time duration or window, where the window can be determined by hardware specification or can be configured from reference device(s) or the gNB. Similarly, for SRS resource #1 and SRS resource #2, if the gap of the transmission time of the two SRS resources is not small (e.g., more than a certain threshold or time gap such as 10 milliseconds, ms), the UE may decide two SRS resources may have different common timing errors, although they are transmitted from the same Tx antenna. Then, for example, the UE reports (Tx TEG #1, TXCI #1) for SRS resource #1 and reports (Tx TEG #1, TXCI #2) for SRS resource #2. Although some of the examples refer to gap in time exceeding a certain threshold value such as 10 ms, the threshold value of 10 ms is an example as other values may be used as well.

Referring again to FIG. 2, the UE 204 may transmit, at 214, on the uplink(s) the SRS on the resources allocated by the gNB 202 for SRS (SRS resources), in accordance with some example embodiments. At 216, the gNB 202 may perform the relative time of arrival (RTOA) measurements for each SRS resource, in accordance with some example embodiments.

At 218, the UE 204 may report to the location management function 206 the transmit error group (TEG) ID and/or a transmit calibration indicator (TXCI) for each SRS resource. The Tx timing error group (TEG) ID and a transmit calibration indicator (TXCI) enables the location management function to determine whether to perform a calibration of the RTOA measurements. Although some of the examples refer to the TXCI being reported with the TEG ID, the TXCI may be sent without the TEG ID and/or in a message separate from the message carrying the TEG ID.

At 220, the gNB 202 may report to the location management function 206 the measurements (e.g., the RTOA measurements) performed on the SRS resources, in accordance with some example embodiments.

At 222, the location management function 206 may determines whether (or not) to calibrate the RTOA measurement for one or more of the SRS resources, in accordance with some example embodiments. The determination of whether to calibrate or not is based on the Tx timing error group (TEG) ID and/or a transmit calibration indicator (TXCI), in accordance with some example embodiments. For example, a UE Tx TEG ID may be associated with a certain error range such as [0, X1 ns], and the LMF may be provided with a calibration value such as X2 nanoseconds (e.g., where X2<X1) to compensate the timing error of RTOA measurements associated with the Tx TEG. A specific RTOA measurement may be obtained from a SRS resource, and the SRS resource may be associated with a UE Tx TEG ID. The LMF may calculate the RTOA measurement using the provided calibration value depending on TXCI value. And, the location management function may calculate, at 222, the time difference measurements and may perform, at 224, a localization of the UE, in accordance with some example embodiments.

Referring again to 218, the UE 204 may send to the network (e.g., a node in the network including the location management function 206, a gNB/base station, another node of the cellular network, a node in the cellular core network) association information among SRS resources that have the same Tx TEG. This association information lets the network know whether calibration of the RTOA measurement is necessary (or not). For each SRS resource, the UE may send an identifier, such as Tx timing error group (TEG) ID, and an indicator, such as the transmit calibration indication (TXCI). If the TXCI is the same between different SRS resources (having the same TEG TX ID), the network (e.g., the location management function) may determine it does not need to calibrate or compensate for the UE transmit error.

The following provides an illustrative example. If for example, the UE 204 transmits SRS resource #1, resource #2, and so forth through resource #N using a quantity N different transmit antennas and the SRS resources #1-#N are associated with the different transmit error group (TEG) ID, the UE may send at 218 the following: (Tx TEG #1, TXCI #1), (Tx TEG #2, TXCI #2), . . . , (Tx TEG #N, TXCI #N). The N different transmit antennas may have different timing error range such that the n-th transmit antenna has an error range [0, Xn], Xn is different for all n E {1, 2, . . . , N}, and Tx TEG ID #n is associated with each error range. As such, each transmit antenna is associated with a unique Tx TEG ID. If however the UE 204 transmits SRS resource #1, resource #2, and so forth through resource #N using a single transmit antenna, the SRS resources are naturally associated with the same Tx timing error group (TEG) ID and the same transmit calibration indication (TXCI). For quantity N SRS resources for example, the UE may send at 218 the following: (Tx TEG #1, TXCI #1), (Tx TEG #1, TXCI #1), . . . , (Tx TEG #1, TXCI #1).

Even if the UE 204 transmits the SRS resources (e.g., SRS carried by uplink resources) using the same transmit antenna, the transmit timing errors in the RTOA measurements may be different if the SRS resources are transmitted with a relatively large time gap such as 10˜100 ms, although other thresholds or times may be used as well. For example, the SRS resource #1 and SRS resource #2 may be transmitted within a first uplink slot, while SRS resource #3 and SRS resource #4 are transmitted within a second slot. If there is a relatively large time gap (e.g., which exceeds a threshold time) between the first slot (which includes SRS resource #1 and SRS resource #2) and the second slot (which includes SRS resource #2 and SRS resource #3), the UE may not be able to assume a common transmit error (among the SRS resource transmission) even when those SRS resources are transmitted by the same transmit antenna. When this is the case, as association information for the four SRS resources may include TXCI information that indicates that the common transmit error is not the same across all of the SRS resource transmission. For example, the UE may send at 218 the following as association information for the four SRS resources: (Tx TEG #1, TXCI #1), (Tx TEG #1, TXCI #1), (Tx TEG #1, TXCI #2), (Tx TEG #1, TXCI #2). Thus, the SRS resource #1-#4 are all share the same TEG ID (e.g., TxTEG #1), but the TXCI indicators are different (e.g., SRS resource #1 and SRS resource #2 have TXCI #1 while the SRS resource #3 and SRS resource #4 have TXCI #2) to indicate to the LMF to calibrate (e.g., given the time gap (and error) associated with the use of two different slots).

Referring again to 216, the gNB 202 may measure RTOA #1 (e.g., based on the SRS resource #1), RTOA #2 (e.g., based on the SRS resource #2), . . . , RTOA #N (e.g., based on the SRS resource #N), and SRS resource #N, and reports at 220 the measurements to the LMF.

Referring again to 222, the location management function 206 may calculate the time difference measurement(s) using the RTOA measurements without the calibration (which are reported at 220) using the association information (e.g., Tx TEG ID, #TXCI), when the Tx TEG IDs are the same and the #TXCIs are the same, such as when the association information reported at 218 includes (Tx TEG #1, #1), (Tx TEG #1, #1), . . . , (Tx TEG #1, #1). In other words, the indicator, such as the TXCI, informs the LMF if a calibration is necessary for two different RTOA measurements associated with the same Tx TEG. For example, if both the Tx TEG #ID and the TXCI #ID are the same, the LMF does not need to calibrate. But if the Tx TEG #IDs or the TXCI #IDs are different, the LMF needs to calibrate.

If however the UE 204 reports at 218 different transmit calibration indication (TXCI) values for the four SRS resources (e.g., (Tx TEG #1, #1) for SRS resource #1, (Tx TEG #1, #1) for SRS resource #2, (Tx TEG #1, #2) for SRS resource #3, (Tx TEG #1, #2) for SRS resource #4), the location management function 206 may calibrate the reported RTOA measurements using transmit timing error information on the UE Tx TEG before calculating the time difference measurement if the TXCI values are different. For example, since the UE reported the same TXCI value for RTOA #1 and RTOA #2 measurement, the LMF does not calibrate these two RTOA measurements when the LMF calculate the time difference between RTOA #1 and RTOA #2. However, if the LMF calculates time difference between RTOA #1 and RTOA #3, since the UE has reported different value of TXCI, the LMF calibrate both RTOA measurements considering the timing error calibration value for Tx TEG #1.

If the UE 204 reports at 218 the same transmit calibration indication (TXCI) values for N SRS resources (e.g., (Tx TEG #1, TXCI #1), (Tx TEG #1, TXCI #1), . . . , (Tx TEG #1, TXCI #1), the location management function 206 may consider the RTOA measurements have a common transmit timing error, so the location management function may directly calculate time difference measurements, without performing a calibration of the RTOA measurements reported at 220.

In other words, when the location management function calculates time difference measurement using two RTOA measurements reported at 220 for example, if the two RTOA measurements are estimated using two different SRS resources associated with different transmit calibration indication (TXCI) values, the location management function may calibrate the RTOA measurements using transmit timing error information on UE Tx TEG before calculating time difference. If two RTOA measurements are associated with two different transmit calibration indication (TXCI) values, the location management function determines that these two RTOA measurements may have uncalibrated transmit timing errors (which may need calibration to compensate for the timing errors before performing a time difference measurement for localizing the UE). But if the two RTOA measurements are associated with the same transmit calibration indication (TXCI) value, the location management function determines these two RTOA measurements do not have uncalibrated errors (so no need for calibration to compensate for the timing errors before performing a time difference measurement for localizing the UE). This may enable the location management function to better select which measurements to use in the positioning calculation.

Although some of the examples refer to the network as the location management function, the network may comprise other nodes as well, such as one or more gNBs and/or one or more transmission reception points (TRPs). For example, the UE 204 may report the Tx TEG ID, TXCI information to the gNB using a higher layer signaling protocol (e.g., RRC signaling). When this is the case, the gNB can send the Tx TEG ID, TXCI information to the location management function (e.g., via a positioning protocol, such as NRPPa (NR Positioning Protocol A, see, e.g., 3GPP TS 38.455 version 15.0.0 Release 15).

In some example embodiments, the UE 204 may send to the network the TXCI information in a dynamic manner. For example, the TXCI may be sent dynamically in the sense that the UE may report the TXCI in an aperiodic manner, rather than the periodic information reporting based on the LMF's request and/or based on the reporting triggering mechanism from gNB using downlink control information (DCI) or MAC-CE. In case that the LMF/gNB does not need periodic update of TXCI information, the LMF may request the UE to report TXCI information for each SRS resource at a certain reporting instance. Alternatively, or additionally, the TXCI may be sent together or separate from the TEG reporting at 218.

In some example embodiments, the UE 204 may report the TXCI information along with every TEG report (which itself may be dynamic or static). In some example embodiments, the UE may report the TXCI information using, for example, RRC (Radio Resource Control) signaling. In some example embodiments, the UE may report the TXCI information using LPP (LTE Positioning Protocol) signaling. In some example embodiments, the UE may use event based reporting to update the network on the TXCI information associated with SRS resources. If for example, an event is triggered such that TXCI information associated with SRS resources are changed, the UE may report the updated TXCI information to the LMF.

In some example embodiments, the UE may not report the association information of a MIMO SRS resource with a specific Tx TEG, but the UE still knows which MIMO SRS is transmitted with a specific transmit antenna so the UE naturally knows the Tx TEG information associated with a specific MIMO SRS resource. Moreover, the UE may send the TXCI value on a specific MIMO SRS resource to implicitly inform the location management function that the transmitted MIMO SRS resource has the same transmit timing error with a specific positioning SRS resource. If for example the UE sends a TXCI #1 for a MIMO SRS resource as association information, the location management function understands that an RTOA measurement associated with this MIMO SRS resource has the common transmit timing error with another RTOA measurement estimated by a positioning SRS resource associated with the same indicator. In this case however, the UE should report that it has a single Tx TEG.

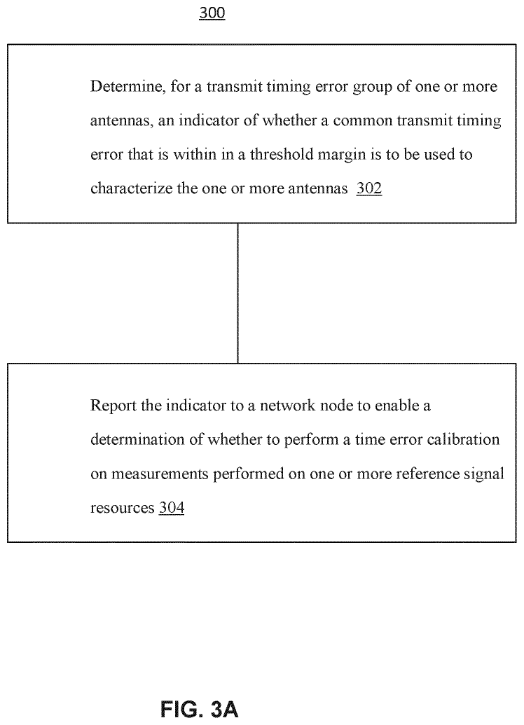

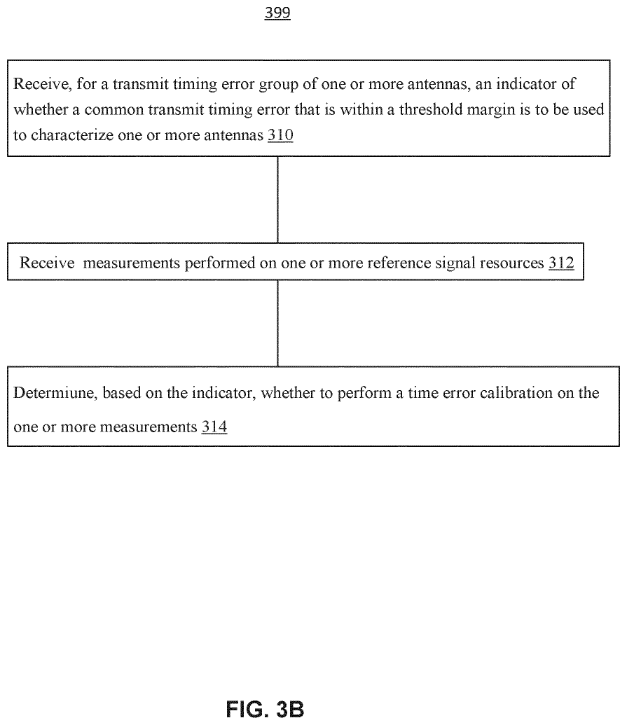

FIG. 3A process 300 which may be performed by a device such as a UE for determining an indicator, such as the TXCI, in accordance with some example embodiments.

At 302, the UE may determine whether a common transmit timing error (which is within in a threshold margin) is to be used to characterize one or more antennas. For example, the UE 204 may determine the indicator, such as the TXCI. The TXCI may indicate whether there is a common transmit timing error (which is within a threshold timing error margin). For example, if the same antenna panel is used to transmit SRS resources on an uplink and there is no gap between transmission of these SRS resources (or the gap is within a threshold time gap as noted above), the timing error may be common (or the same) among the transmitted SRS resources. In this example, the UE may determine that the same TXCI may be used for the transmitted SRS resources as noted above with respect to 212 and other examples herein. Likewise, if the same antenna panel is used to transmit SRS resources on an uplink and there is a large time gap (e.g., which exceeds the threshold time gap) between transmission of these SRS resources, the timing error may be not be common among the transmitted SRS resources. In this case, the UE may determine that the different TXCI values may be used as noted above with respect to 212 and other examples herein. When the timing error is common, the LMF does not need to calibrate the measurements received at 220 as the timing errors cancel out. But when the timing error is not common (or the same), the LMF does need to calibrate the measurements received at 220 as the timing errors.

At 304, the UE may report the indicator to a network node to enable a determination of whether to perform a time error calibration on measurements performed on sounding reference signal resources. Referring again to 218, the UE 204 may report the indicator, such as the TXCI. The TXCI may be reported along with the Tx TEG ID.

FIG. 3B process 399 for a network node, such as a location management function, for determining whether to perform a calibration of measurements, in accordance with some example embodiments.

At 310, a network node, such as the LMF, may receive, for a transmit timing error group of antennas, an indicator of whether a common transmit timing error (which is within a threshold margin) is to be used to characterize one or more antennas. This indicator may comprise the TXCI disclosed herein, for example. Referring to FIG. 2, the LMF 206 may receive the TXCI at 218 from the UE (although the LMF may also receive the TXCI from other network nodes such as the gNB).

At 312, the measurements may be received, wherein the measurements are performed on one or more reference signal resources. For example, the LMF 206 may receive RTOA measurements reported by the gNB as noted above with respect to 220. The one or more reference signal resources may include one or more sounding reference signal resources, one or more sidelink reference signals, one or more physical random access channel resources, and/or other types of reference signal which can be used for positioning.

At 314, a determination is made regarding whether to perform a time error calibration on the measurements. For example, the LMF may determine whether to perform the time error calibration of the RTOA measurements based on the value of the indicator, such as the TXCI. For example, if the indicator correspond to the common transmit timing error (which exceeds a threshold margin), the LMF may perform the time error calibration on the measurements for the sounding reference signal resources transmitted by a single antenna. But if the common transmit timing error does not exceed the threshold margin, the LMF may inhibit (i.e., not perform) the time error calibration on the measurements for sounding reference signal resources transmitted by a single antenna.

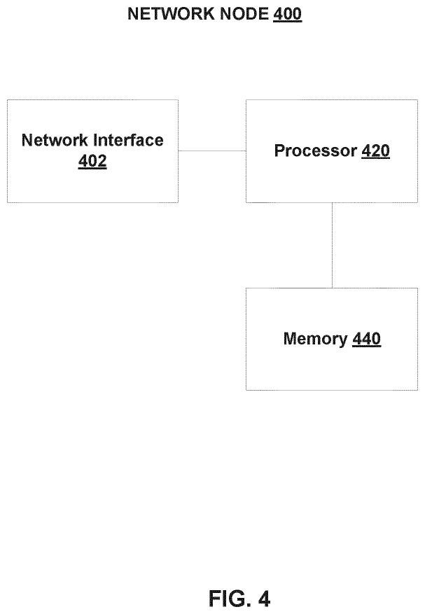

FIG. 4 depicts a block diagram of a network node 400, in accordance with some example embodiments. The network node 400 may comprise or be comprised in one or more network side nodes or functions (e.g., gNB, eNB, TRPs, LMFs, and/or the like).

The network node 400 may include a network interface 402, a processor 420, and a memory 404, in accordance with some example embodiments. The network interface 402 may include wired and/or wireless transceivers to enable access other nodes including base stations, other network nodes, the Internet, other networks, and/or other nodes. The memory 404 may comprise volatile and/or non-volatile memory including program code, which when executed by at least one processor 420 provides, among other things, the processes disclosed herein with respect to the network nodes.

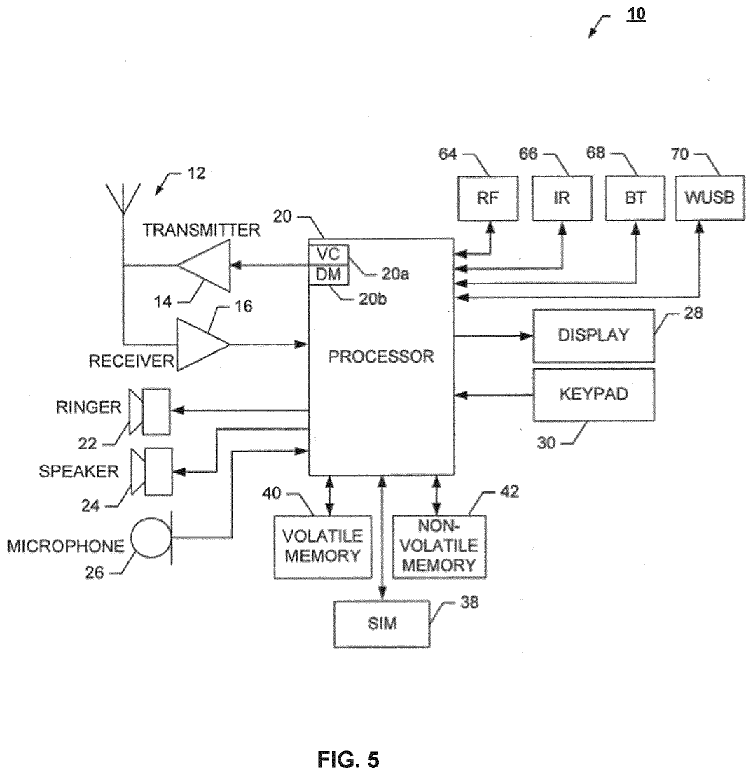

FIG. 5 illustrates a block diagram of an apparatus 10, in accordance with some example embodiments. The apparatus 10 may comprise or be comprised in a user equipment, such as user equipment 204. In general, the various embodiments of the user equipment 204 can include cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions, in addition for vehicles such as autos and/or truck and arial vehicles such as manned or unmanned aerial vehicle and as well as portable units or terminals that incorporate combinations of such functions. The user equipment may comprise or be comprised in an IoT device, an Industrial IoT device, and/or the like. In the case of an IoT device or ITOT device, the UE may be configured to operate with less resources (in terms of for example power, processing speed, memory, and the like) when compared to a smartphone, for example.

The apparatus 10 may include at least one antenna 12 in communication with a transmitter 14 and a receiver 16. Alternatively transmit and receive antennas may be separate. The apparatus 10 may also include a processor 20 configured to provide signals to and receive signals from the transmitter and receiver, respectively, and to control the functioning of the apparatus. Processor 20 may be configured to control the functioning of the transmitter and receiver by effecting control signaling via electrical leads to the transmitter and receiver. Likewise, processor 20 may be configured to control other elements of apparatus 10 by effecting control signaling via electrical leads connecting processor 20 to the other elements, such as a display or a memory. The processor 20 may, for example, be embodied in a variety of ways including circuitry, at least one processing core, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits (for example, an application specific integrated circuit (ASIC), a field programmable gate array (FPGA), and/or the like), or some combination thereof. Accordingly, although illustrated in FIG. 5 as a single processor, in some example embodiments the processor 20 may comprise a plurality of processors or processing cores.

The apparatus 10 may be capable of operating with one or more air interface standards, communication protocols, modulation types, access types, and/or the like. Signals sent and received by the processor 20 may include signaling information in accordance with an air interface standard of an applicable cellular system, and/or any number of different wireline or wireless networking techniques, comprising but not limited to Wi-Fi, wireless local access network (WLAN) techniques, such as Institute of Electrical and Electronics Engineers (IEEE) 802.11, 802.16, 802.3, ADSL, DOCSIS, and/or the like. In addition, these signals may include speech data, user generated data, user requested data, and/or the like.

For example, the apparatus 10 and/or a cellular modem therein may be capable of operating in accordance with various first generation (1G) communication protocols, second generation (2G or 2.5G) communication protocols, third-generation (3G) communication protocols, fourth-generation (4G) communication protocols, fifth-generation (5G) communication protocols, Internet Protocol Multimedia Subsystem (IMS) communication protocols (for example, session initiation protocol (SIP) and/or the like. For example, the apparatus 10 may be capable of operating in accordance with 2G wireless communication protocols IS-136, Time Division Multiple Access TDMA, Global System for Mobile communications, GSM, IS-95, Code Division Multiple Access, CDMA, and/or the like. In addition, for example, the apparatus 10 may be capable of operating in accordance with 2.5G wireless communication protocols General Packet Radio Service (GPRS), Enhanced Data GSM Environment (EDGE), and/or the like. Further, for example, the apparatus 10 may be capable of operating in accordance with 3G wireless communication protocols, such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The apparatus 10 may be additionally capable of operating in accordance with 3.9G wireless communication protocols, such as Long Term Evolution (LTE), Evolved Universal Terrestrial Radio Access Network (E-UTRAN), and/or the like. Additionally, for example, the apparatus 10 may be capable of operating in accordance with 4G wireless communication protocols, such as LTE Advanced, 5G, and/or the like as well as similar wireless communication protocols that may be subsequently developed.

It is understood that the processor 20 may include circuitry for implementing audio/video and logic functions of apparatus 10. For example, the processor 20 may comprise a digital signal processor device, a microprocessor device, an analog-to-digital converter, a digital-to-analog converter, and/or the like. Control and signal processing functions of the apparatus 10 may be allocated between these devices according to their respective capabilities. The processor 20 may additionally comprise an internal voice coder (VC) 20a, an internal data modem (DM) 20b, and/or the like. Further, the processor 20 may include functionality to operate one or more software programs, which may be stored in memory. In general, processor 20 and stored software instructions may be configured to cause apparatus 10 to perform actions. For example, processor 20 may be capable of operating a connectivity program, such as a web browser. The connectivity program may allow the apparatus 10 to transmit and receive web content, such as location-based content, according to a protocol, such as wireless application protocol, WAP, hypertext transfer protocol, HTTP, and/or the like.

Apparatus 10 may also comprise a user interface including, for example, an earphone or speaker 24, a ringer 22, a microphone 26, a display 28, a user input interface, and/or the like, which may be operationally coupled to the processor 20. The display 28 may, as noted above, include a touch sensitive display, where a user may touch and/or gesture to make selections, enter values, and/or the like. The processor 20 may also include user interface circuitry configured to control at least some functions of one or more elements of the user interface, such as the speaker 24, the ringer 22, the microphone 26, the display 28, and/or the like. The processor 20 and/or user interface circuitry comprising the processor 20 may be configured to control one or more functions of one or more elements of the user interface through computer program instructions, for example, software and/or firmware, stored on a memory accessible to the processor 20, for example, volatile memory 40, non-volatile memory 42, and/or the like. The apparatus 10 may include a battery for powering various circuits related to the mobile terminal, for example, a circuit to provide mechanical vibration as a detectable output. The user input interface may comprise devices allowing the apparatus 20 to receive data, such as a keypad 30 (which can be a virtual keyboard presented on display 28 or an externally coupled keyboard) and/or other input devices.

As shown in FIG. 5, apparatus 10 may also include one or more mechanisms for sharing and/or obtaining data. For example, the apparatus 10 may include a short-range radio frequency (RF) transceiver and/or interrogator 64, so data may be shared with and/or obtained from electronic devices in accordance with RF techniques. The apparatus 10 may include other short-range transceivers, such as an infrared (IR) transceiver 66, a Bluetooth™ (BT) transceiver 68 operating using Bluetooth™ wireless technology, a wireless universal serial bus (USB) transceiver 70, a Bluetooth™ Low Energy transceiver, a ZigBee transceiver, an ANT transceiver, a cellular device-to-device transceiver, a wireless local area link transceiver, and/or any other short-range radio technology. Apparatus 10 and, in particular, the short-range transceiver may be capable of transmitting data to and/or receiving data from electronic devices within the proximity of the apparatus, such as within 10 meters, for example. The apparatus 10 including the Wi-Fi or wireless local area networking modem may also be capable of transmitting and/or receiving data from electronic devices according to various wireless networking techniques, including 6LoWpan, Wi-Fi, Wi-Fi low power, WLAN techniques such as IEEE 802.11 techniques, IEEE 802.15 techniques, IEEE 802.16 techniques, and/or the like.

The apparatus 10 may comprise memory, such as a subscriber identity module (SIM) 38, a removable user identity module (R-UIM), an eUICC, an UICC, U-SIM, and/or the like, which may store information elements related to a mobile subscriber. In addition to the SIM, the apparatus 10 may include other removable and/or fixed memory. The apparatus 10 may include volatile memory 40 and/or non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices, for example, hard disks, floppy disk drives, magnetic tape, optical disc drives and/or media, non-volatile random access memory (NVRAM), and/or the like. Like volatile memory 40, non-volatile memory 42 may include a cache area for temporary storage of data. At least part of the volatile and/or non-volatile memory may be embedded in processor 20. The memories may store one or more software programs, instructions, pieces of information, data, and/or the like which may be used by the apparatus for performing operations disclosed herein.

The memories may comprise an identifier, such as an international mobile equipment identification (IMEI) code, capable of uniquely identifying apparatus 10. The memories may comprise an identifier, such as an international mobile equipment identification (IMEI) code, capable of uniquely identifying apparatus 10. In the example embodiment, the processor 20 may be configured using computer code stored at memory 40 and/or 42 to the provide operations disclosed herein with respect to the UE (e.g., one or more of the processes, calculations, and the like disclosed herein including the process at FIG. 3).

Some of the embodiments disclosed herein may be implemented in software, hardware, application logic, or a combination of software, hardware, and application logic. The software, application logic, and/or hardware may reside on memory 40, the control apparatus 20, or electronic components, for example. In some example embodiments, the application logic, software or an instruction set is maintained on any one of various conventional computer-readable media. In the context of this document, a “computer-readable storage medium” may be any non-transitory media that can contain, store, communicate, propagate or transport the instructions for use by or in connection with an instruction execution system, apparatus, or device, such as a computer or data processor circuitry; computer-readable medium may comprise a non-transitory computer-readable storage medium that may be any media that can contain or store the instructions for use by or in connection with an instruction execution system, apparatus, or device, such as a computer.

Without in any way limiting the scope, interpretation, or application of the claims appearing below, a technical effect of one or more of the example embodiments disclosed herein may include enhanced positioning and/or reduced burden on network nodes (e.g., reducing unnecessary calibrations).

The subject matter described herein may be embodied in systems, apparatus, methods, and/or articles depending on the desired configuration. For example, the base stations and user equipment (or one or more components therein) and/or the processes described herein can be implemented using one or more of the following: a processor executing program code, an application-specific integrated circuit (ASIC), a digital signal processor (DSP), an embedded processor, a field programmable gate array (FPGA), and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device. These computer programs (also known as programs, software, software applications, applications, components, program code, or code) include machine instructions for a programmable processor, and may be implemented in a high-level procedural and/or object-oriented programming language, and/or in assembly/machine language. As used herein, the term “computer-readable medium” refers to any computer program product, machine-readable medium, computer-readable storage medium, apparatus and/or device (for example, magnetic discs, optical disks, memory, Programmable Logic Devices (PLDs)) used to provide machine instructions and/or data to a programmable processor, including a machine-readable medium that receives machine instructions. Similarly, systems are also described herein that may include a processor and a memory coupled to the processor. The memory may include one or more programs that cause the processor to perform one or more of the operations described herein.

Although a few variations have been described in detail above, other modifications or additions are possible. In particular, further features and/or variations may be provided in addition to those set forth herein. Moreover, the implementations described above may be directed to various combinations and subcombinations of the disclosed features and/or combinations and subcombinations of several further features disclosed above. Other embodiments may be within the scope of the following claims.

If desired, the different functions discussed herein may be performed in a different order and/or concurrently with each other. Furthermore, if desired, one or more of the above-described functions may be optional or may be combined. Although various aspects of some of the embodiments are set out in the independent claims, other aspects of some of the embodiments comprise other combinations of features from the described embodiments and/or the dependent claims with the features of the independent claims, and not solely the combinations explicitly set out in the claims. It is also noted herein that while the above describes example embodiments, these descriptions should not be viewed in a limiting sense. Rather, there are several variations and modifications that may be made without departing from the scope of some of the embodiments as defined in the appended claims. Other embodiments may be within the scope of the following claims. The term “based on” includes “based on at least.” The use of the phase “such as” means “such as for example” unless otherwise indicated.

1. A method comprising:
determining, for a transmit timing error group of one or more antennas, an indicator of whether a common transmit timing error that is within in a threshold margin is to be used to characterize the one or more antennas; and
reporting the indicator to a network node to enable a determination of whether to perform a time error calibration on one or more measurements performed on one or more reference signal resources.

2. The method of claim 1, wherein the indicator comprises a transmit calibration indicator.

3. The method of claim 1, wherein the indicator is determined for each of the one or more reference signal resources.

4. The method of claim 1, wherein the indicator is reported with a transmit error group identifier.

5.-16. (canceled)

17. An apparatus comprising:
at least one processor; and
at least one memory including computer program code, the at least one memory and the computer program code configured to, with the at least one processor, cause the apparatus to at least:
determine, for a transmit timing error group of one or more antennas, an indicator of whether a common transmit timing error that is within in a threshold margin is to be used to characterize the one or more antennas; and
report the indicator to a network node to enable a determination of whether to perform a time error calibration on one or more measurements performed on one or more reference signal resources.

18. The apparatus of claim 17, wherein the indicator comprises a transmit calibration indicator.

19. The apparatus of claim 17, wherein the indicator is determined for each of the one or more reference signal resources.

20. The apparatus of claim 17, wherein the indicator is reported with a transmit error group identifier.

21. The apparatus of claim 17, wherein the apparatus is further caused to at least:
receive configuration information including one or more reference signal resources on an uplink, wherein for each of the one or more reference signal resources, the determining includes determining a corresponding indicator and a corresponding transmit timing error group identifier.

22. The apparatus of claim 17, wherein the network node comprises, or is comprised in, at least one of a location management function or a base station.

23. The apparatus of claim 17, wherein the indicator is reported via radio resource control message and/or a positioning protocol.

24. The apparatus of claim 17, wherein the indicator is reported as event based reporting, and wherein the event includes a change of the indicator for the one or more reference signal resources.

25. The apparatus of claim 17, wherein the one or more reference signal resources comprise one or more sounding reference signal resources, one or more sidelink reference signals, and/or one or more physical random access channel resources.

26. An apparatus comprising:
at least one processor; and
at least one memory including computer program code, the at least one memory and the computer program code configured to, with the at least one processor, cause the apparatus to at least:
receive, for a transmit timing error group of antennas, an indicator of whether a common transmit timing error that is within a threshold margin is to be used to characterize one or more antennas;
receive one or more measurements performed on one or more reference signal resources; and
determine, based on the indicator, whether to perform a time error calibration on the one or more measurements.

27. The apparatus of claim 26, wherein the determination further causes the apparatus to at least:
in response to the indicator being determined as indicating that the common transmit timing error exceeds the threshold margin, perform the time error calibration on the one or more measurements for one or more reference signal resources.

28. The apparatus of claim 27, wherein the receiving further includes receiving a first transmit timing error group identifier and a first indicator value for a first reference signal resource and further receiving the first transmit timing error group identifier and a second indicator value for a second reference signal resource.

29. The apparatus of claim 26, wherein the determination further causes the apparatus to at least:
in response to the indicator being determined as indicating that the common transmit timing error does not exceed the threshold margin, inhibit the performance of the time error calibration on the one or more measurements for one or more reference signal resources.

30. The apparatus of claim 29, wherein the receiving further includes receiving a first transmit error group identifier and a first indicator value for a first reference signal resource and further receiving the first transmit error group identifier and the first indicator value for a second reference signal resource.

31. The apparatus of claim 26, wherein the indicator is received with a transmit timing error group identifier.

32. The apparatus of claim 26, wherein the one or more reference signal resources comprise one or more sounding reference signal resources, one or more sidelink reference signals, and/or one or more physical random access channel resources.

33.-38. (canceled)
